(19) United States
(12) Patent Application Publication
(10) Pub. No.: US 2002/0113485 A1
(43) Pub. Date: Aug. 22, 2002

(54) Wheel reflectors for vehicles

(76) Inventors: Cedric Ketter, Boynton Beach, FL (US); Harly Pierre, Delray Bch., FL (US)

Correspondence Address: Robert M. Downey, ROBERT M. DOWNEY, P.A., Suite 350, 150 E. Palmetto Park Road, Boca Raton, FL, 33432, US

(21) Appl. No.: 10/033,881

(22) Filed: Dec. 20, 2001

Related U.S. Application Data
(60) Provisional application No. 60/257,521, filed on Dec. 21, 2000.

(51) Int. Cl. B60B 7/00

(52) U.S. Cl. 301/37.108

(57) ABSTRACT

A reflector device for attachment to the wheel rim of an automobile includes a main body which may be rigid and formed in a circular shape or, alternatively, of a flexible material adapted to be easily configured to the circular shape of the wheel rim. The main body includes an exposed first side, an opposite second side, and a light reflective surface visible on the exposed first side. The second side of the main body is provided with an adhesive for attaching the device to an annular surface on the wheel rim.

### BACKGROUND OF THE INVENTION

1. Field of the Invention

The present invention relates to reflectors for wheels of a vehicle and, more particularly, to a reflector device having an exposed light reflective surface and wherein the device is particularly adapted for attachment to an annular surface of a wheel rim to provide a circular reflector on the vehicle wheel.

2. Discussion of the Related Art

Light reflectors are well known and have been used on many types of vehicles, such as bicycles, motorcycles, cars and trucks, for enhancing their visibility at night. Additionally, lights of various type have been used extensively on vehicles to provide greater visibility to the driver of the vehicle, as well as to make the vehicle more visible to others. Lights have also been used to provide aesthetic visual effects, thereby making the vehicle more attractive at night. Some of these lighting systems provide a dual function of both safety and enhanced appearance. More particularly, vehicle wheel lighting devices and systems have been proposed to illuminate the wheels of a vehicle at night. Examples of vehicle wheel lighting devices can be seen in the following U.S. Patents:

U.S. Pat. No. 5,800,035 to Aichele;

U.S. Pat. No. 5,530,630 to Williams, Jr.;

U.S. Pat. No. 4,881,153 to Scott; and

U.S. Pat. No. 5,634,707 to Bailey, Jr.

And, while these various vehicle wheel lighting systems and devices are intended to provide an enhanced decorative appearance to the vehicle when driving at night, the use of electrically powered lights on rotating wheels requires a complex power delivery system and light mounting system. Due to rigorous demands on vehicle wheels which rotate at high RPM's under extreme conditions, it is very difficult to maintain an electrical connection between one or more electric lights and a power source, such as the vehicle's battery. For this reason, most attempts to provide an electrically powered vehicle wheel lighting system have failed.

Light reflectors provide a convenient alternative to electrically powered lights, particularly when applied to moving objects, such as rotating wheels on a vehicle. In fact, it is well known to attach reflectors to bicycle wheels, particularly to the spokes of the wheel in order to make enhance the visibility of a bicycle when it is dark. Notwithstanding, there has been little attention paid to wheels of motorized vehicles when it comes to use of light reflectors.

The present invention is specifically directed to the motor vehicle industry and provides a circular light reflector device which attaches to a smooth annular surface on the rim of an automobile's wheel. The light reflector device of the present invention is intended to both provide a decorative effect as well as to enhance the visibility of a vehicle, thereby providing a safety feature.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded perspective view illustrating attachment of the reflector device of the present invention to an outer facing annular surface of a vehicle wheel rim in accordance with one preferred embodiment of the present invention;

FIG. 2 is a front perspective view of an alternative embodiment of the light reflector device of FIG. 1;

FIG. 3 is a side elevational view of the light reflector device of the embodiments of FIGS. 1 and 2;

FIG. 4 is an exploded perspective view illustrating attachment of the light reflector device of the present invention to an inner annular surface of a vehicle wheel rim in accordance with a second preferred embodiment of the present invention;

FIG. 6 is an exploded cross-section of an alternative embodiment of the reflector device of the first and second preferred embodiment embodiments of FIGS. 1 and 4, respectively; and

FIG. 7 is an exploded view in cross-section of yet another alternative embodiment of the reflector device of the first and second preferred embodiments of FIGS. 1 and 4, respectively.

Like reference numerals refer to like parts throughout the several views of the drawings.

### DETAILED DESCRIPTION OF THE PREFERRED EMBODIMENTS

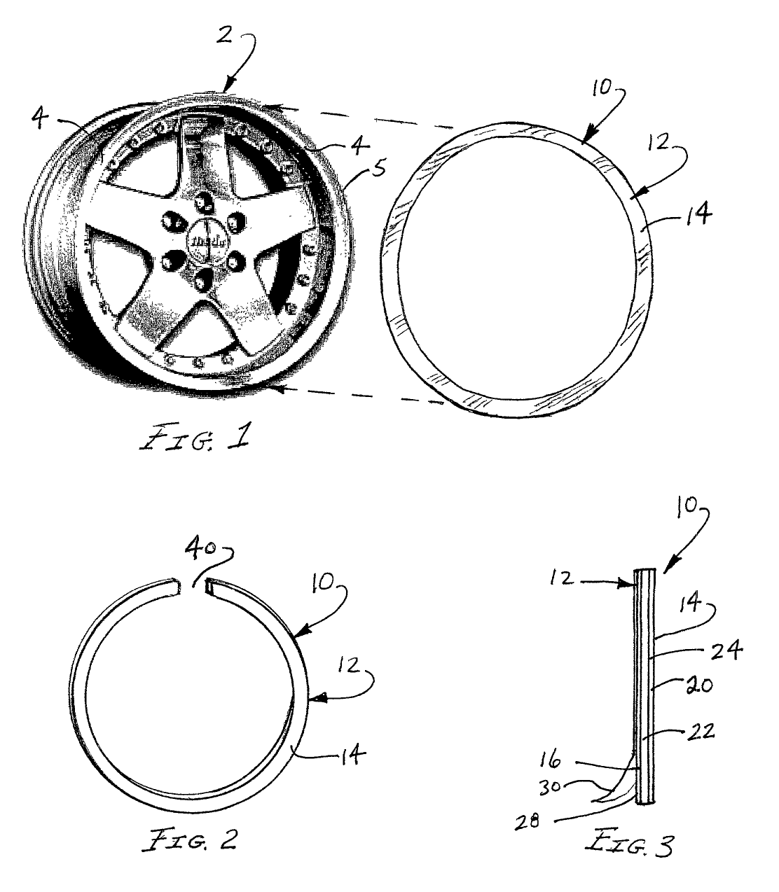

Referring to the several views of the drawings, and initially FIG. 1, the present invention is directed to a light reflector device for attachment to a vehicle wheel rim 2, wherein a first preferred embodiment of the light reflective device is generally indicated as 10 in FIGS. 1-3.

In the embodiment of FIG. 1, the light reflective device 10 is formed of a rigid material, such as a plastic composition, and is molded in a circular configuration, as shown. The device 10 is particularly adapted for attachment to an outer facing annular rim surface 4 on the vehicle wheel rim 2. The device 10 includes a main body 12 having a first side 14 and an opposite side 16. In a preferred embodiment, as seen in FIG. 3, the light reflector device 10 includes a clear, transparent lens portion 20 on the first side 14. Below the clear plastic lens, there is a light reflective material composition 22 with a light reflective surface 24 which is visibly exposed through the clear lens 20 on the first side 14 of the device 10. The opposite second side 16 is provided with an adhesive substance forming a layer 28. Prior to use, the adhesive layer 28 is covered with a protective film 30 which is peeled away just prior to attachment of the device 10 to the annular rim surface 4. By peeling away the protective film 30, a tacky surface of the adhesive layer is exposed. The device 10 is positioned in alignment with the exposed annular rim surface 4 and moved against the rim surface, as illustrated by the arrows in FIG. 1, to suitably attach the device 10 to the rim 2, so that the tacky surface of the adhesive layer mates against the exposed rim surface 4.

FIG. 2 illustrates an alternative embodiment of FIG. 1, wherein the circular configuration of the device 10 is partially opened, as at 40, to permit slight flexing of the device in order to adjust the circumference. This permits the circumference of the device to be slightly reduced during attachment of the device 10 to the wheel rim, whereupon releasing of a compressing force upon placement of the device on the wheel rim 2 causes the device to expand in snug fitting engagement with an outer annular lip 5 on the vehicle rim. This helps to hold the device 10 on the vehicle rim 2 when the wheel of the vehicle is rotating. Similar to the embodiment of FIG. 1, the embodiment of FIG. 2 includes an adhesive layer, as illustrated in FIG. 3, and attachment is achieved in the same manner as described in connection with the embodiment of FIG. 1.

The embodiment of FIG. 1 may alternatively be manufactured in a thin flexible substrate, similar to a tape, in a circular form. In this particular embodiment, the tape would include the top reflective surface 14 and an opposite adhesive surface 16 with a peel-away film 30. This particular embodiment would eliminate the clear plastic lens 20 described in connection with reference to FIG. 3. Also, the adhesive substance on the rear face 16 would have a thickness which would not be readily discernible, and therefore, would not be described as a layer. Instead, the adhesive would be similar to that found on the rear face of tape.

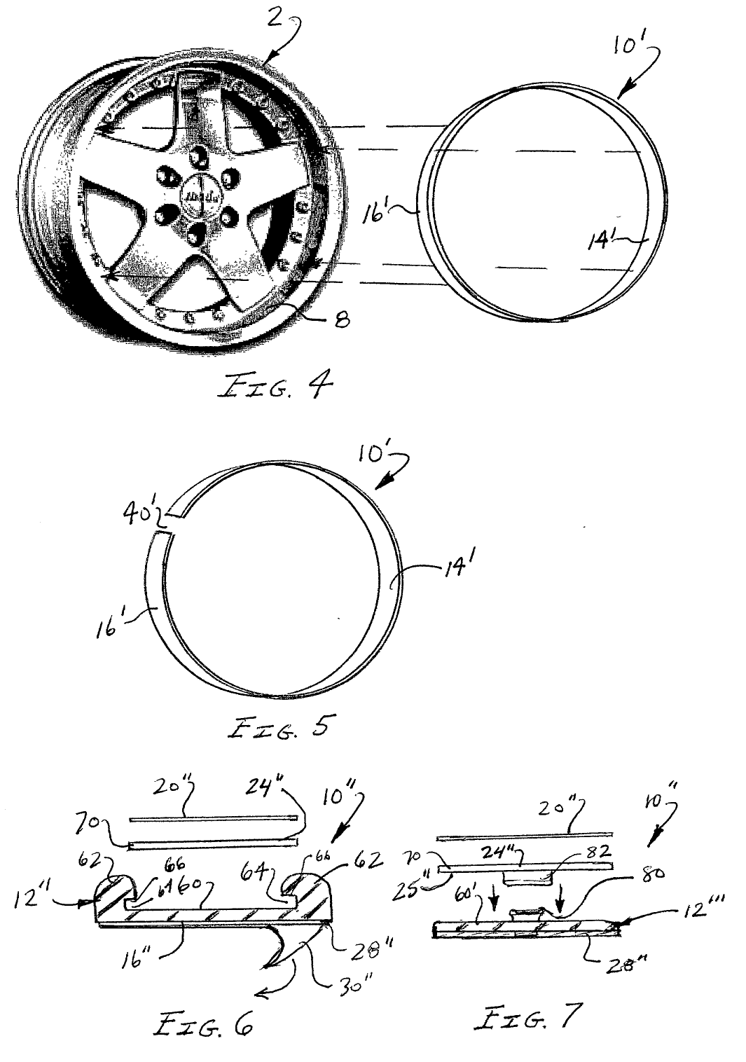

Referring to FIG. 4, a second preferred embodiment of the reflective device is shown and is indicated as 10′. This particular embodiment is formed as a circular collar which fits within the confines of the rim and mates against an inner annular surface 8 of the rim 2. The device 10 includes a first side 14′ and an opposite side 16′ which mates with the surface 8 of the rim. Similar to the embodiment described in connection with FIG. 1, the circular reflective device 10′ of FIG. 4 may be constructed as a multi-layered component, as seen similar to that described in connection with FIG. 3, or as a thin flexible tape. In either instance, a reflective surface is visible on the first side 14′, while an adhesive substance is provided on the opposite side 16′ for mating, attached engagement with the rim surface 8.

FIG. 5 shows an alternative embodiment of the reflective device 10′ of FIG. 4 and is provided with a gap 40′ to permit flexing of the circular reflective device 10′ in order to reduce the overall circumference for adjusting to different rim diameters, and to provide a tighter fit of the device to the rim surface 8. Specifically, by applying a compressive force to close the gap 40′) the circumference of the device 10′ of FIG. 5 is reduced, allowing the device 10′ to be received within the wheel rim 2. Upon releasing the compressive force, the reflective device 10′ expands causing the outer surface 16′ to mate with the rim surface 8. A flexible memory of the material used in the manufacture of the device 10′ causes the device to spring outwardly, urging the surface 16′ against the rim surface 8, thereby holding the device 10′ on the rim. A suitable adhesive may be provided on the side 16′ so as to provide a secure attachment.

Referring to FIGS. 6 and 7, yet another embodiment of the reflective device is shown and is indicated as 10″. In FIG. 6, the device includes a base 12″ having a first side 60 and an opposite side 16″. The second opposite side 16″ is provided with an adhesive layer 28″ which is protectively covered with a film 30″ prior to use. The base 12″ may be configured in a circular shape, similar to that shown in FIGS. 1 or 4 for attachment to either the outer annular rim surface 4 or the inner annular rim surface 8, respectively. In the embodiment shown in FIG. 6, the base 12″ is provided with longitudinal side rail portions 62 which are shaped and configured to define a track 64 with overhanging lip portions 66. The track 64 is specifically sized and configured for receipt of a reflective substrate 70 therein having an upper reflective surface 24″. The device 10″ is further provided with a lens 20″ which is preferably formed of a thin transparent sheet material. The lens 20″ overlies the reflective surface 24″ of the reflective substrate 70 and is formed and configured for sliding receipt within the channel 64 along with the reflective substrate 70. The overhanging lip 66 on either side of the channel serve to maintain the reflective substrate 70 and lens 20″ within the channel 64 and against the top surface 60 of the base 12″.

Referring to FIG. 7, yet another embodiment is shown wherein the base is indicated as 12′″. In this particular embodiment, the bottom surface of the base is provided with an adhesive layer 28″ similar to that described in connection with FIG. 6. Likewise, a peel away protective film may be provided for covering the adhesive layer 28″ prior to use. The top surface 60′ of the base 12′″ is provided with a plurality of male snap fastening members 80 at spaced intervals for snap fit receipt within correspondingly positioned female snap fastening members 82 on the rear side 25″ of the reflective substrate 70. The opposite side of the reflective substrate 70 is provided with the reflective surface 24″ which is visibly exposed on the top of the base 12′″ when the reflective substrate 70 is attached thereto. A transparent protective lens 20″ may be provided in covering relation to the reflective surface 24″, similar to that described in connection with the embodiment of FIG. 6. To retain the lens 20″ on the base 12′″, an adhesive backing may be provided on the lens 20″.

While the instant invention has been shown and described in connection with various embodiments thereof, it is recognized that departures may be made from the instant disclosure and such departures are contemplated within the spirit and scope of the present invention.

What is claimed is:

1. A wheel rim assembly for a vehicle comprising:
a wheel rim body structured and disposed for mounting a tire thereon and comprising:
means for mounting said wheel rim body to the vehicle; and
an annular exposed surface;
a circular body comprising:
a first main face;
an opposite second face;
a light reflective material visibly exposed through said first main face; and
means for attaching said circular body to said exposed annular surface of said wheel rim body so that said first main face and said reflective material are visibly exposed when said wheel rim body is mounted to the vehicle.

2. The assembly as recited in claim 1 wherein said means for attaching said circular body to said annular exposed surface of said wheel rim body comprises and adhesive material on said second face for mating attachment to said annular exposed surface.

3. The assembly as recited in claim 1 wherein said means for attaching said circular body to said annular exposed surface of said wheel rim body comprises a flexible memory in said circular body urging said circular body to a normally relaxed enlarged circumference upon releasing a compressive force and wherein said circular body assumes a reduced circumference upon application of said compressive force.
